(19) United States
(12) Patent Application Publication
(10) Pub. No.: US 2016/0221394 A1
(43) Pub. Date: Aug. 4, 2016

(54) Aircraft Tire Crown Reinforcement

(71) Applicants: COMPAGNIE GENERALE DES ETABLISSEMENTS MICHELIN, Clermont-Ferrand (FR); MICHELIN RECHERCHE ET TECHNIQUE S.A., Granges-Psccot (CH)

(72) Inventor: Marc ROMERO DE LA OSA, Clermont-Ferrand Cedex 9 (FR)

(21) Appl. No.: 15/026,909

(22) PCT Filed: Oct. 22, 2014
(86) PCT No.: PCT/EP2014/072610

§ 371 Date: Apr. 1, 2016

(30) Foreign Application Priority Data
Oct. 23, 2013 (FR) 1360306

(51) Int. Cl. B60C 9/20; B29D 30/30; B60C 9/00; B60C 9/02; B60C 11/00

(52) U.S. Cl. CPC B60C 9/2003; B60C 9/02; B60C 11/00; B60C 9/0042; B29D 30/3035; B60C 2009/2016; B60C 2009/2035; B60C 2009/2038; B60C 2009/0035

(57) ABSTRACT

An aircraft tire (1) comprises a working reinforcement (2) radially on the inside of a tread (3) and radially on the outside of a carcass reinforcement (4), comprising at least one working bi-ply (5) made up at least in part of two working layers (6, 7) and comprising, at each axial end, an axial-end additional thickness (51). Each working layer (6, 7) is made up of an axial juxtaposition of strips (8) of width W, a strip (8) having a mid-line (81) extending circumferentially along a periodic curve (9) forming, in the equatorial plane (XZ) and with the circumferential direction (XX′), a non-zero angle A and a radius of curvature R at its extrema (10). The ratio R/W is at most equal to N/(1−cosA)+½, such that each axial-end additional thickness (51) comprises at most (N+2) working layers.

The present invention relates to an aircraft tire and, in particular, to the working reinforcement of an aircraft tire.

In general, a tire comprises a tread, intended to come into contact with the ground via a tread surface, the tread being connected by two sidewalls to two beads, the two beads being intended to provide a mechanical connection between the tire and the rim on which the tire is mounted.

In what follows, the circumferential, axial and radial directions of the tire respectively denote a direction tangential to the tread surface of the tire in the direction of rotation of the tire, a direction parallel to the axis of rotation of the tire and a direction perpendicular to the axis of rotation of the tire. “Radially on the inside or, respectively, radially on the outside” means “closer to or, respectively, further away from the axis of rotation of the tire”. “Axially on the inside or, respectively, axially on the outside” means “closer to or, respectively, further away from the equatorial plane of the tire”, the equatorial plane of the tire being the plane that passes through the middle of the tread surface of the tire and perpendicular to the axis of rotation of the tire.

A radial aircraft tire more particularly comprises a radial carcass reinforcement and a crown reinforcement both as described, for example, in document EP 1381525.

The radial carcass reinforcement is the tire reinforcing structure that connects the two beads of the tire. The radial carcass reinforcement of an aircraft tire generally comprises at least one carcass layer, each carcass layer being made up of reinforcers, usually textile, coated in a polymeric material of the elastomer or elastomer compound type, the reinforcers being mutually parallel and forming, with the circumferential direction, an angle of between 80° and 100°.

The crown reinforcement is the reinforcing structure of the tire radially on the inside of the tread and at least partially radially on the outside of the radial carcass reinforcement. The crown reinforcement of an aircraft tire generally comprises at least one crown layer, each crown layer being made up of mutually parallel reinforcers coated in a polymeric material of the elastomer or elastomer compound type. Among the crown layers a distinction is usually made between the working layers that constitute the working reinforcement, usually made up of textile reinforcers, and the protective layers constituting the protective reinforcement, made up of metal or textile reinforcers and arranged radially on the outside of the working reinforcement. The working layers govern the mechanical behaviour of the crown reinforcement. The protective layers essentially protect the working layers from attack likely to spread through the tread radially towards the inside of the tire. A crown layer, and particularly a working layer, is geometrically characterized by its axial width, which means the distance between its axial ends.

The textile reinforcers of the carcass layers and of the crown layers are usually cords made of spun textile filaments, preferably made of aliphatic polyamide or of aromatic polyamide. The mechanical properties under tension (modulus, elongation and breaking force) of the textile reinforcers are measured after prior conditioning. “Prior conditioning” means the storage of the textile reinforcers for at least 24 hours, prior to measurement, in a standard atmosphere in accordance with European Standard DIN EN 20139 (temperature of 20±2° C.; relative humidity of 65±2%). The measurements are taken in the known way using a ZWICK GmbH & Co (Germany) tensile test machine of type 1435 or type 1445. The textile reinforcers are subjected to tension over an initial length of 400 mm at a nominal rate of 200 mm/min. All the results are averaged over 10 measurements.

An elastomeric material, such as the one used to coat the reinforcers of the carcass layers and of the crown layers, can be mechanically characterized, after curing, by tensile stress/strain characteristics determined by tensile testing. This tensile testing is carried out on a test specimen according to a method known to those skilled in the art, for example in accordance with international standard ISO 37 and under normal temperature (23+or −2° C.) and relative humidity (50+or −5% relative humidity) conditions defined by international standard ISO 471. The elastic modulus at 10% elongation on an elastomeric compound, expressed in megapascals (MPa), is the name given to the tensile stress measured for a 10% elongation of the test specimen.

During the manufacture of an aircraft tire and, more specifically, during the step of laying the working reinforcement, a working layer is usually obtained by a circumferential zigzag winding or by a circumferential winding in turns of a strip made up of at least one continuous textile reinforcer coated in an elastomeric compound, on the lateral surface of a building drum. Whether produced by circumferential zigzag winding or circumferential winding in turns, the working layer is then made up of the juxtaposition of a width of strip for each turn of winding.

Circumferential zigzag winding means a winding in the circumferential direction of the tire and with a periodic curve, which means to say one formed of periodic waves oscillating between extrema. Winding a strip with a periodic curve means that the mid-line of the wound strip, defined as being the line equidistant from the edges of the strip, coincides with the periodic curve. The peak-to-peak amplitude between the extrema of the periodic curve thus defines the axial width of the working layer, namely the distance between the axial ends thereof. The period of the periodic curve is usually between 0.5 times and 3 times the circumference of the building drum on which the strip is laid. The periodic curve is also characterized by the angle it forms in the equatorial plane of the tire with the circumferential direction of the tire, and by a radius of curvature, at the extrema of the periodic curve. For a conventional zigzag winding, the angle of the periodic curve, which corresponds to the angle formed by the textile reinforcers, one parallel to the next, that make up the strip, is generally between 5° and 35° with respect to the circumferential direction. During circumferential zigzag winding the working layers are usually laid in pairs, each pair of working layers constituting a working bi-ply. A working bi-ply is made up at least in part of two working layers, namely in the main section axially on the inside of the two axial ends of the working bi-ply. In addition, a working bi-ply comprises more than two radially superposed working layers at its axial ends. The maximum number of additional working layers, in the radial direction, in comparison with the two working layers of the working bi-ply is referred to as the axial-end additional thickness. This axial-end additional thickness is generated by the crossings of strip at the end of the working layer for each turn of zigzag winding. Such a working reinforcement comprising working layers obtained by circumferential zigzag winding of a strip has been described in documents EP 0240303, EP 0850787, EP 1163120 and EP 1 518 666.

A circumferential winding in turns means a winding in the circumferential direction of the tire and in a helix of diameter equal to the diameter of the building drum on which the strip is laid and with a mean angle of between 0° and 5° with respect to the circumferential direction. The working layer thus obtained by winding in turns is said to be circumferential because the angle of the textile reinforcers of the strip, one parallel to the next formed in the equatorial plane with the circumferential direction, is between 0° and 5°. The principle of circumferential winding in turns leads to the creation of a single working layer rather than a working bi-ply as was obtained with zigzag winding.

In the case of circumferential zigzag winding, it is known that the axial end additional thicknesses of the working bi-plies are particularly sensitive to the onset of endurance damage, such as cracks which may evolve into significant degradation of the working reinforcement and, therefore, reduce the life of the tire.

The inventors have set themselves the objective of improving the endurance of the working reinforcement of an aircraft tire by reducing the sensitivity to the risk of cracking of the axial end additional thicknesses of the working bi-plies that make up the working reinforcement.

This objective has been achieved, according to the invention, by an aircraft tire comprising:
working reinforcement radially on the inside of a tread and radially on the outside of a carcass reinforcement,
the working reinforcement comprising at least one working bi-ply made up at least in part of two working layers which are radially superposed and comprising, at each axial end, an axial-end additional thickness comprising more than two radially superposed working layers,
each working layer being made up of an axial juxtaposition of strips of width W,
each strip having a mid-line extending circumferentially along a periodic curve oscillating between extrema,
the periodic curve forming, in the equatorial plane and with the circumferential direction, a non-zero angle A and having a radius of curvature R at its extrema, the ratio R/W between the radius of curvature R, at the extrema of the periodic curve of the mid-line of the strip, and the width W of the strip being at most equal to N/(1−cosA)+½, such that each axial-end additional thickness of the working bi-ply comprises at most (N+2) working layers.

In other words, for a given strip width W and a given angle A, the radius of curvature R at the extrema of the periodic curve of the mid-line of the strip must not exceed a maximum value, so as not to exceed a given number of superposed working layers at the axial end additional thicknesses. More specifically, this condition relating to the radius of curvature R makes it possible not to pass beyond N additional layers, at the axial end additional thicknesses, with respect to the two layers of the working bi-ply, in the main section axially on the inside of the axial ends. Limiting the radius of curvature amounts to limiting the number of superpositions of layers at the axial ends of the working bi-ply. This is because the higher the radius of curvature, the greater the number of superpositions.

This maximum number N of additional layers, at the axial end additional thicknesses, causes the number of interfaces between the working layers in this zone to be minimized, thereby minimizing the risk of cracks appearing in the axial end additional thicknesses and hence improving the endurance of the working bi-ply and therefore of the working reinforcement. It also leads to a reduction in the thickness of the axial end additional thicknesses by comparison with a conventional working bi-ply and therefore leads to a lowering of the temperature in this zone, something which likewise improves the endurance of the working reinforcement. Finally, it results in a reduction in the mass of the working bi-ply, and therefore that of the tire, thereby contributing to a gain in payload that the aircraft can carry, this being something that is of constant concern to aircraft manufacturers.

According to a first embodiment in which the periodic curve forms, in the equatorial plane and with the circumferential direction, a non-zero angle A strictly less than 10, the ratio R/W between the radius of curvature R, at the extrema of the mid-line of the periodic curve of the strip, and the width W of the strip is at most equal to 1/(1−cosA)+½, such that each axial-end additional thickness of the working bi-ply comprises at most 3 working layers.

According to a second embodiment in which the periodic curve forms, in the equatorial plane and with the circumferential direction, an angle A at least equal to 10° and strictly less than 20°, the ratio R/W between the radius of curvature R, at the extrema of the periodic curve of the mid-line of the strip, and the width W of the strip is at most equal to 2/(1-cosA)+½, such that each axial-end additional thickness of the working bi-ply comprises at most 4 working layers.

According to a third embodiment in which the periodic curve forms, in the equatorial plane and with the circumferential direction, an angle A at least equal to 20°, the ratio R/W between the radius of curvature R, at the extrema of the periodic curve of the mid-line of the strip, and the width W of the strip is at most equal to 3/(1−cosA)+½, such that each end additional thickness of the working bi-ply comprises at most 5 working layers.

The inventors have demonstrated the fact that choosing a radius of curvature that generates a small end additional thickness of the working bi-ply, and therefore few superpositions, becomes increasingly difficult as the angle A increases, bearing in mind the various geometric constraints resulting from the principle of laying the strip along a periodic curve. Therefore the minimum number of superpositions at the end of the working bi-ply increases as the angle A increases.

Thus, for a non-zero angle A strictly less than 10° it is possible to find a maximum radius of curvature R that generates at most 3 additional working layers at the end of the working bi-ply. For an angle A at least equal to 10° and strictly less than 20°, the minimum possible number of additional working layers at the end of the working bi-ply is 4. For an angle A at least equal to 20°, the minimum possible number of additional working layers at the end of the working bi-ply is 5.

Advantageously, the ratio R/W between the radius of curvature R, at the extrema of the periodic curve of the mid-line of the strip, and the width W of the strip is at least equal to 10. In other words, the radius of curvature R needs to be large enough in comparison with the width W of the strip. This minimum value makes it possible to avoid the risk of the strip buckling outside its plane while the strip is being laid during manufacture, during the changes in direction at the extrema of the periodic curve.

For preference, the ratio R/W between the radius of curvature R, at the extrema of the periodic curve of the mid-line of the strip, and the width W of the strip is at least equal to 13. This minimum value makes it possible to avoid the risk of the strip buckling outside its plane while the strip is being laid during manufacture, during the changes in direction at the extrema of the periodic curve.

The width W of the strip is advantageously at least equal to 2 mm, preferably at least equal to 8 mm A minimum value of strip width is necessary both for the technological feasibility of the strip and for the productivity of the laying of the strip. Moreover, the nearer the strip width is to this minimum value, the more the radius of curvature can be reduced, thereby in particular making it possible to reduce the axial width of the axial end additional thickness of the working bi-ply, namely of the zone potentially sensitive to cracking.

Advantageously too, the width W of the strip is at most equal to 20 mm, preferably at most equal to 12 mm A maximum value of strip width makes it possible to reduce the number of turns over which the strip is laid in a zigzag needed to create the working bi-ply, thereby reducing the time needed to create the working bi-ply and therefore increasing productivity.

It is advantageous for the strip to comprise reinforcers made of a textile material, preferably of an aliphatic polyamide. This is because textile reinforcers, particularly made of aliphatic polyamides such as nylon, have a relatively low mass in comparison with metal reinforcers, thereby allowing a significant saving on the mass of the tire and therefore a gain in the payload that the aircraft can carry.

Alternatively, the strip comprises reinforcers made of an aromatic polyamide. Reinforcers made of aromatic polyamide, such as aramid, in fact make it possible to achieve a good compromise between mechanical strength and weight.

Another solution is to have a strip comprising reinforcers made of a combination of an aliphatic polyamide and of an aromatic polyamide. Such reinforcers are generally referred to as hybrid reinforcers and offer the technical advantages of nylon and of aramid: mechanical strength, tensile deformability and lightness of weight.

The invention also relates to a method of obtaining a tire comprising a working bi-ply according to the invention.

More specifically, the invention also relates to a method of manufacturing an aircraft tire according to any one of the embodiments described hereinabove, this method comprising a step of manufacturing a working bi-ply, in which the working bi-ply is obtained by circumferential zigzag winding of a strip of width W with a periodic curve and on to the lateral surface of a building drum of radius R_{f}.

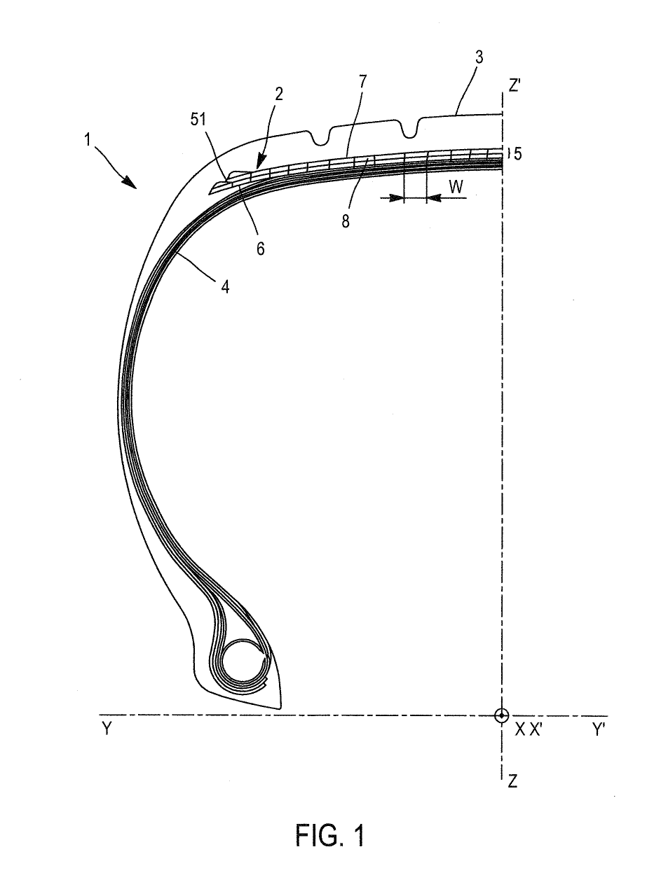

The features and other advantages of the invention will be better understood with the aid of FIGS. 1 to 5, which have not been drawn to scale:

FIG. 1: a half-view in section of an aircraft tire according to the invention, in a radial plane (YZ) passing through the axis of rotation of the tire.

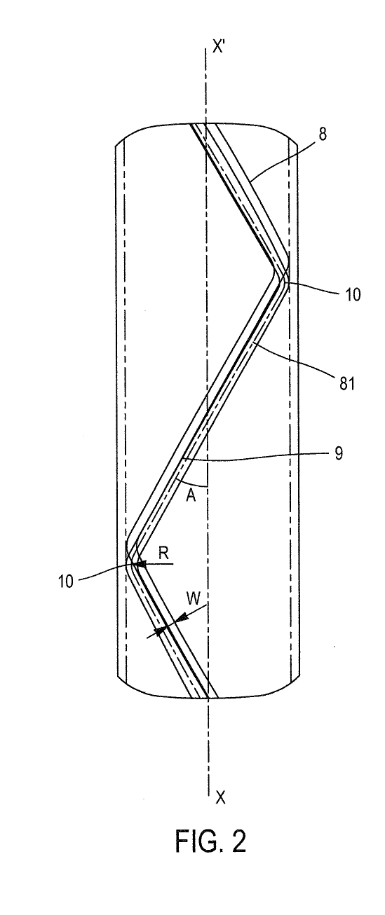

FIG. 2: a general arrangement of a strip that makes up a working bi-ply of a tire according to the invention.

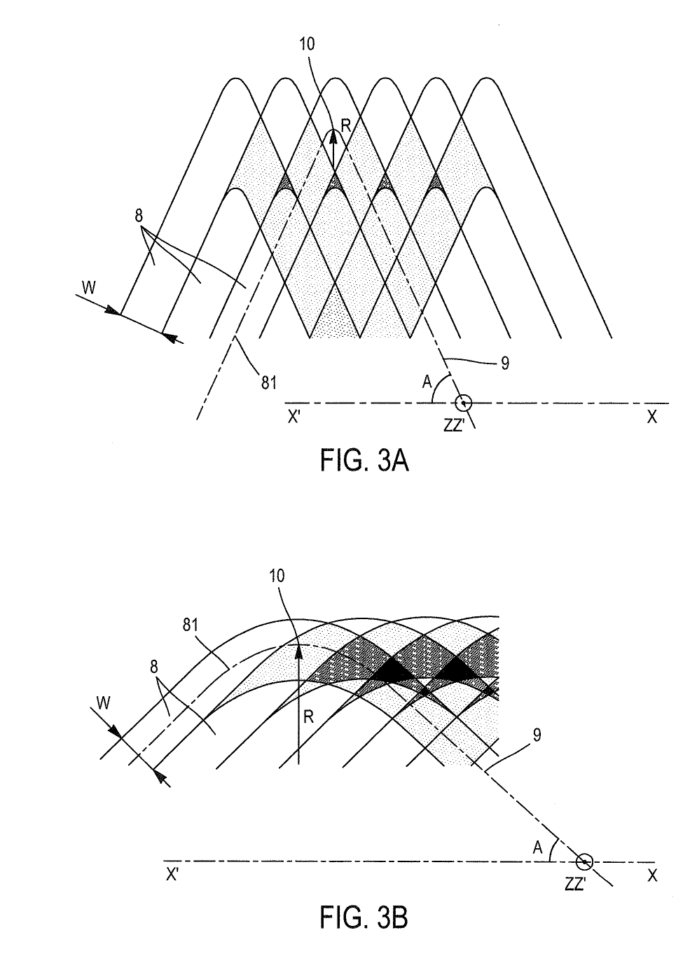

FIGS. 3A and 3B: plan views of an axial end of a working bi-ply of a tire according to the invention, for two different radii of curvature.

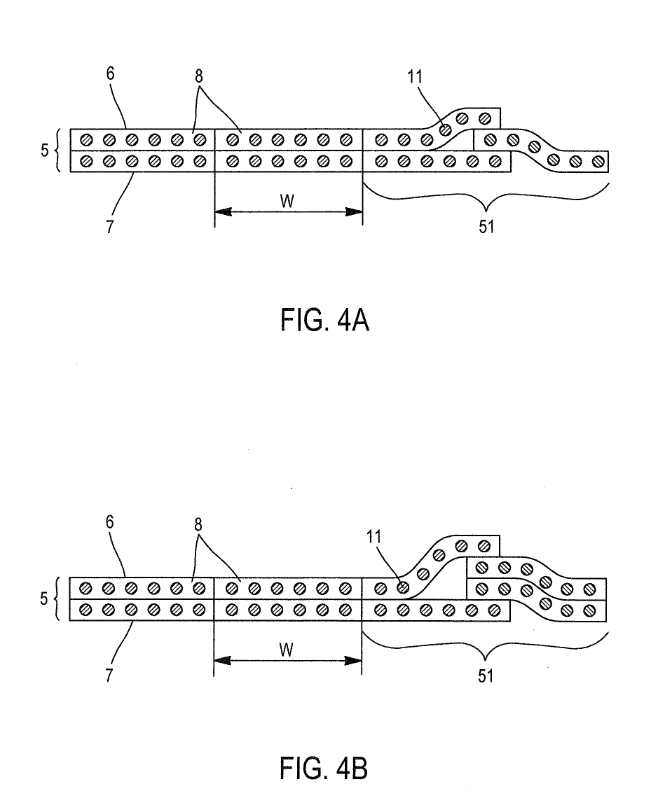

FIGS. 4A and 4B: views in section of an axial end additional thickness of a working bi-ply of a tire according to the invention, in a radial plane (YZ), for two different radii of curvature.

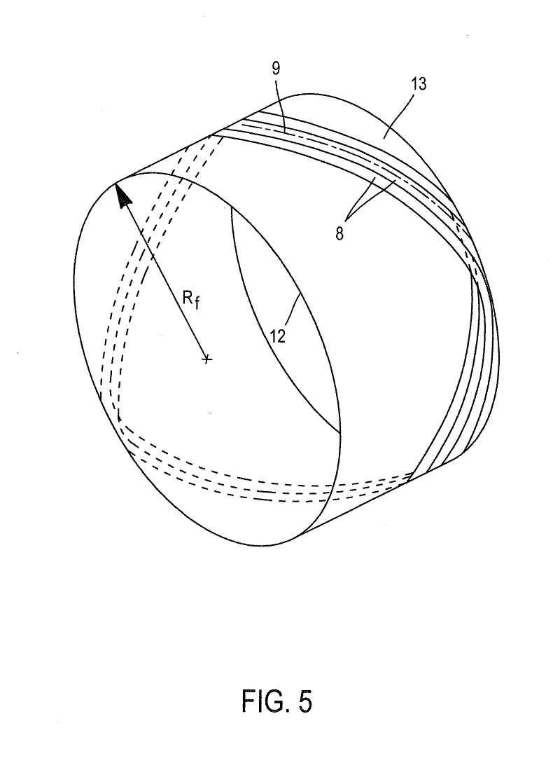

FIG. 5: a perspective view of a strip circumferentially wound in a zigzag, with a periodic curve on the lateral surface of a building drum.

FIG. 1 depicts a half-view in section, in a radial plane (YZ) passing through the axis of rotation of the tire, of an aircraft tire 1 comprising a working reinforcement 2 radially on the inside of a tread 3 and radially on the outside of a carcass reinforcement 4. The working reinforcement 2 comprises at least one working bi-ply 5 made up at least in part of two working layers (6, 7) which are radially superposed and comprise, at each axial end, an axial end additional thickness 51 comprising more than two radially superposed working layers (6, 7). Each working layer (6, 7) is made up of an axial juxtaposition of strips 8 of width W.

FIG. 2 depicts a general arrangement of a strip 8 that makes up a working bi-ply of a tire according to the invention. The strip 8 of width W has a mid-line 81, running circumferentially, namely in the direction (XX′) along a periodic curve 9 comprising extrema 10. In other words, the periodic curve 9 is the curve supporting the mid-line 81 of the strip 8. The periodic curve 9 forms, in the equatorial plane (XZ) and with the circumferential direction (XX′), a non-zero angle A. The periodic curve 9 oscillates between extrema 10, at which the radius of curvature R is defined.

FIGS. 3A and 3B respectively depict plan views of an axial end of a working bi-ply of a tire according to the invention, for two different radii of curvature. Each of these figures depicts the axial juxtaposition of a strip 8 of width W, of mid-line 81, along the periodic curve 9 having extrema 10 at which it has a radius of curvature R. Furthermore, the mid-line 81 forms a non-zero angle A, in the equatorial plane (XZ) and with the circumferential direction (XX′). FIG. 3A corresponds to a ratio R/W between the radius of curvature R, at the extrema 10 of the periodic curve 9 of the mid-line 81 of the strip 8, and the width W of the strip 8, equal to 27. The white zone corresponds to one thickness of strip, the pale grey zone corresponds to two thicknesses of strip and the dark grey zone corresponds to three thicknesses of strip. FIG. 3B corresponds to a ratio R/W between the radius of curvature R, at the extrema 10 of the periodic curve 9 of the mid-line 81 of the strip 8, and the width W of the strip 8, equal to 127. In this case, the maximum number of superpositions, corresponding to the darkest zone, corresponds to four thicknesses of strip.

FIGS. 4A and 4B are views in section, in a radial plane (YZ), of an axial end additional thickness 51 of a working bi-ply 5 of a tire according to the invention, for two different radii of curvature. Each of these figures shows a working bi-ply 5, made up of the radial superposition of two working layers (6, 7), each working layer (6, 7) being made up of an axial juxtaposition of strips 8 of width W, in the main section, namely on the section axially on the inside of the axial end additional thicknesses 51 of the working bi-ply 5. In FIG. 4A, the axial end additional thickness 51 comprises 3 working layers that are at least partially superposed, corresponding to an R/W ratio at most equal to 1/(1-cosA)+½, for a non-zero angle A strictly less than 10. In FIG. 4B, the axial end additional thickness 51 comprises 4 working layers that are at least partially superposed, corresponding to an R/W ratio at most equal to 2/(1-cosA)+½, for an angle A at least equal to 10° and strictly less than 20°.

FIG. 5 is a perspective view of a strip 8 wound circumferentially in a zigzag, with a periodic curve 9, on the lateral surface 13 of a tire building drum 12 of radius R_{f}. It illustrates a method of manufacturing an aircraft tire according to the invention.

The inventors carried out the invention for an aircraft tire of size 1400×530 R 23.

In the tire investigated, the strip that makes up the working bi-ply has a width W of 11 mm and has a mid-line that forms an angle of 10° with the circumferential direction of the tire. The radius of curvature R of said mid-line is taken equal to 180 mm, leading to an R/W ratio equal to 16, very much below the maximum recommended value of 2/(1−cosA)+½, namely 132. Indeed, from a practical standpoint, the radius of curvature is chosen to be very much smaller than the maximum recommended value, while at the same time being as close as possible to the minimum recommended value equal to 10, preferably equal to 13, being positioned at the limit of the risk of the strip buckling as it is wound in a zigzag.

Thus, the chosen value 16 for the R/W ratio does indeed satisfy the two conditions: being greater than 13 and less than 132. In this particular instance, a maximum superposition of 3 working layers is obtained at the end of the working bi-ply. The gain in endurance of a tire comprising a working bi-ply according to the invention, as compared with a reference tire comprising a working bi-ply in which the axial end additional thickness is not minimized with the minimum radius of curvature equal to 176 mm, leads to an estimated 10% gain in endurance. This endurance is measured in terms of the amount of damage found on a tire subjected to a regulation TSO test as defined by the European Aviation European Safety Agency (EASA).

1. An aircraft tire comprising:
a working reinforcement radially on the inside of a tread and radially on the outside of a carcass reinforcement;
the working reinforcement comprising at least one working bi-ply made up at least in part of two working layers which are radially superposed and comprising, at each axial end, an axial-end additional thickness comprising more than two radially superposed working layers;
each working layer being made up of an axial juxtaposition of strips of width;
each strip having a mid-line extending circumferentially along a periodic curve comprising extrema;
the periodic curve forming, in the equatorial plane and with the circumferential direction, a non-zero angle A and having a radius of curvature R at its extrema;
wherein the ratio R/W between the radius of curvature R, at the extrema of the periodic curve of the mid-line of the strip, and the width W of the strip, is at most equal to N/(1-cosA)+½, such that each axial-end additional thickness of the working bi-ply comprises at most (N+2) working layers.

2. The aircraft tire according to claim 1, the periodic curve forming, in the equatorial plane and with the circumferential direction, a non-zero angle A strictly less than 10, in which wherein the ratio R/W between the radius of curvature R, at the extrema of the mid-line of the periodic curve of the strip, and the width W of the strip is at most equal to 1/(1-cosA)+½, such that each axial-end additional thickness of the working bi-ply comprises at most 3 working layers.

3. The aircraft tire according to claim 1, the periodic curve forming, in the equatorial plane and with the circumferential direction, an angle A at least equal to 10° and strictly less than 20°, wherein the ratio R/W between the radius of curvature R, at the extrema of the periodic curve of the mid-line of the strip, and the width W of the strip is at most equal to 2/(1-cosA)+½, such that each axial-end additional thickness of the working bi-ply comprises at most 4 working layers.

4. The aircraft tire according to claim 1, the periodic curve forming, in the equatorial plane and with the circumferential direction, an angle A at least equal to 20°, in which wherein the ratio R/W between the radius of curvature R, at the extrema of the periodic curve of the mid-line of the strip, and the width W of the strip is at most equal to 3/(1-cosA)+½, such that each end additional thickness of the working bi-ply {-5} comprises at most 5 working layers.

5. The aircraft tire according to claim 1, wherein the ratio R/W between the radius of curvature R, at the extrema of the periodic curve of the mid-line the strip, and the width W of the strip is at least equal to 10.

6. The aircraft tire according to claim 1, wherein the ratio R/W between the radius of curvature R, at the extrema of the periodic curve of the mid-line of the strip, and the width W of the strip is at least equal to 13.

7. The aircraft tire according to claim 1, wherein the width W of the strip is at least equal to 2 mm.

8. The aircraft tire according to claim 1, wherein the width W of the strip is at most equal to 20 mm.

9. The aircraft tire according to claim 1, wherein the strip comprises reinforcers made of a textile material.

10. The aircraft tire according to claim 1, wherein the strip comprises reinforcers made of an aromatic polyamide.

11. The aircraft tire according to claim 1, wherein the strip comprises reinforcers made of a combination of an aliphatic polyamide and of an aromatic polyamide.

12. A method of manufacturing an aircraft tire according to claim 1, comprising a step of manufacturing a working bi-ply, in which the working bi-ply is obtained by circumferential zigzag winding of a strip of width W with a periodic curve and on to the lateral surface of a building drum of radius R_{f}.

13. The aircraft tire according to claim 1, wherein the width W of the strip is at least equal to 8 mm.

14. The aircraft tire according to claim 1, wherein the width W of the strip is at most equal to 2 mm.

15. The aircraft tire according to claim 1, wherein the strip comprises reinforcers made of an aliphatic polyamide.
